(19) United States
(12) Patent Application Publication
(10) Pub. No.: US 2019/0333003 A1
(43) Pub. Date: Oct. 31, 2019

(54) IDENTIFICATION TAG FOR MONITORING A SUPPLY CHAIN OF AN ENTITY OR A WORKFLOW OF PROCESSES

(71) Applicant: HALDOR ADVANDED TECHNOLOGIES LTD, Hod HaSharon (IL)

(72) Inventors: Guy DOR, Rosh Haayn (IL); Dan ZEELI, North York (CA); Ilan KADOSH-TAMARI, Ramat Hasharon (IL)

(21) Appl. No.: 16/309,119

(22) PCT Filed: Jul. 4, 2016
(86) PCT No.: PCT/IL2016/050713

§ 371 Date: Dec. 12, 2018

(51) Int. Cl. G06Q 10/08; G06Q 10/06; H04L 9/32; G06K 19/077

(52) U.S. Cl. CPC G06Q 10/087; G06K 19/07773; H04L 9/32; G06Q 10/0633

(57) ABSTRACT

An identification tag that is attachable to an entity and serves to monitor the supply chain of the entity or workflow of processes related to the entity, including: a transceiver for receiving transmissions and transmitting a response; a memory for storing information; a control for analyzing incoming information, storing information in the memory and providing information from the memory; wherein the memory is preprogrammed with a unique identification code and is configured to store information defining the type of entity attached to the identification tag, a list of processes required to be performed on the entity and status information of the list of processes.

### TECHNICAL FIELD

The present invention relates to the attachment of an identification tag to an entity and using the tag to monitor and record interactions of the supply chain of the entity or workflow of processes.

### BACKGROUND

The supply chain of an entity or workflow of processes related to the entity includes organizations, people, activities, information and resources involved in preparing and/or moving an entity or service from a supplier to a customer and thereafter during usage of the entity and or service. Generally the supply chain and or workflow of processes are computerized by recording each step executed at a processing station using a computerized application on a local workstation.

Typically the workstation is connected to a network and the computerized application on the workstation serves as a client of a server application executed on a computer server. The server application keeps track of the progress of the entities and serves to verify that the entities were processed by all required stations. Optionally, the entity includes products, people, animals or other items that can be monitored.

Optionally, if each entity has a serial number or user ID the server can provide a tracking report that discloses all the processes applied to the entity and all the locations traversed by the entity.

One method of marking the entity with a unique ID includes attaching an RFID tag to the entity and recording in a database on the server the identification information from each tag at each station.

However the above method requires that the workstations have access to the central server. A stand-alone computer is not sufficient and likewise a customer and or end user that does not have access to the central server cannot verify the integrity and quality of entities received by the customer and or workflow processes related to the entity as it is used by the end user. On the contrary, the customer and or a local distributor and or the end user must generally rely on paper documentation shipped with the entity.

### SUMMARY

An aspect of an embodiment of the disclosure relates to an identification tag for attaching to a entity. The identification tag includes a transceiver for receiving wireless RF transmissions and transmitting a wireless RF response. The identification tag further including a memory for storing information and a controller for analyzing incoming transmissions, storing information in the memory and preparing a response based on the contents of the memory. The memory of the identification tag is preprogrammed with a unique identification code and is designed to further store information defining the type of entity it is attached to and a list of processes to be performed on the entity with status information of the processes. Optionally, the status information includes an indicator if the process was performed or not and/or a level of success or score for the process. In some embodiments of the disclosure, the status information includes a list of processes that are prerequisite for the processes.

A further aspect of the invention relates to a method of monitoring the supply chain of an entity or a workflow of processes using the identification tag. Initially an identification tag is attached to the entity to be connected to it for the lifetime of the entity. Initially the type of entity that the identification tag is attached to is written to the memory of the identification tag. Additionally, a list of processes that are required to be performed on that type of entity are written to the memory of the identification tag. The entity is then transferred to processing stations to perform processes on the entity. At each processing station the information in the memory of the identification tag is read and analyzed to determine how to handle the entity, for example if the process of the station needs to be applied to the entity, if all prerequisite processes were performed, to comply with regulatory requirements or manufacturing requirements, or to determine if the content of the memory of the entity is valid. Likewise, after performing the process the information from the identification tag is used to determine where to transfer the entity (e.g. the next process station) and to write information regarding the results of the current process, for example if it succeeded or failed, a result score and/or other information.

A further aspect relates to a system for monitoring the supply chain of the entity or workflow of the processes, wherein the system includes a reader for reading the content of the identification tags and a computer at each processing station with a software application installed to read and write the information in the memory of the identification tags using the reader. The software application associates the unique identification code with the type of entity and provides the list of required processes. Optionally, the system further includes a server computer that is accessible (e.g. over a network) by multiple computers of processing stations. The server forms a list of the identification codes and their associated entity type. Additionally, the server may provide the list of required processes to the computers of the processing stations and may provide updates to the list.

There is thus provided according to an exemplary embodiment of the disclosure, an identification tag that is attachable to an entity and serves to monitor the supply chain of the entity or workflow of processes applied to the entity, comprising:

A transceiver for receiving transmissions and transmitting a response;

A memory for storing information;

A control for analyzing incoming information, storing information in the memory and providing information from the memory;

Wherein the memory is preprogrammed with a unique identification code and is configured to store information defining the type of entity attached to the identification tag, a list of processes required to be performed on the entity and status information of the list of processes.

In an exemplary embodiment of the disclosure, the identification tag is powered by received electromagnetic signals. Alternatively, the identification tag is powered by a battery. Optionally, the identification tag is programmed to notify a reader of a processing station with the information of the type of entity it is attached to, based on the information in the memory. In an exemplary embodiment of the disclosure, the identification tag is programmed to notify a reader of a processing station if the entity is required to undergo a process performed by a processing station based on the information in the memory. Optionally, the status information stored in the memory includes a score for processes performed on the entity. In an exemplary embodiment of the disclosure, the status information stored in the memory includes an indication if a process was performed or not, on the attached entity. Optionally, the information stored in the memory is encrypted so that it is readable and writable only by authorized processing stations. In an exemplary embodiment of the disclosure, the information stored in the memory includes an error detection code to authenticate that the information was recorded by an authorized processing station. Optionally, the information stored in the memory enables a processing station to verify that prior required processes were performed on the entity before performing a process by the processing station.

There is further provided according to an exemplary embodiment of the disclosure, a method of monitoring the supply chain of an entity or workflow of processes applied to the entity, comprising:

Receiving an entity;

Attaching an identification tag to the entity; wherein the identification tag comprises: 1) a transceiver for receiving transmissions and transmitting a response, 2) a memory preprogrammed with a unique identification code and for storing information, and 3) a control for analyzing incoming information, storing information in the memory and providing information from the memory;

Identifying a type of the entity;

Writing the type of entity to the memory;

Writing a list of required processes for the entity to the memory;

Providing the entity to a processing station to perform a process;

Reading information from the memory of the identification tag;

Analyzing the information read from the memory;

Based on said analyzing determining if to perform the process for the entity or to transfer the entity to a different processing station to perform a different process; and

Updating the information in the tag based on the results of the process.

In an exemplary embodiment of the disclosure, the method includes downloading from a server computer over a network the list of required processes based on the type of entity. Optionally, the analyzing comprises verifying that the type of entity written in the memory is correct. In an exemplary embodiment of the disclosure, the analyzing comprises verifying that the information written in the memory has a correct error correction code. Optionally, the analyzing comprises verifying that the information written in the memory was encoded correctly. In an exemplary embodiment of the disclosure, the analyzing comprises verifying that required prior processes are marked as performed. Optionally, the analyzing comprises verifying that the process was not performed yet for the entity. In an exemplary embodiment of the disclosure, the unique identification code is associated with the type of entity in a list on a server computer that is accessible over a network. Optionally, the memory is used to record a list of identification codes of items used in a first process and to verify that the recorded items exist or are removed in a second process.

There is further provided according to an exemplary embodiment of the disclosure, a system for monitoring the supply chain of an entity or workflow of processes applied to the entity, comprising:

A reader configured to read the information of an identification tag as described above that is attached to the entity;

A workstation computer at a processing station with a software application for reading and writing information in a memory of the identification tag;

Wherein the software application associates the unique identification code stored in the memory of the identification tag with the type of entity and provides the list of required processes to be written in the memory of the identification tag.

In an exemplary embodiment of the disclosure, the system further includes a server computer that is connected over a network to multiple workstation computers and forms a list of identification codes and their associated entity type from information provided by the multiple workstation computers. Optionally, the server computer provides the list of required processes to the multiple workstation computers.

### BRIEF DESCRIPTION OF THE DRAWINGS

The present disclosure will be understood and better appreciated from the following detailed description taken in conjunction with the drawings. Identical structures, elements or parts, which appear in more than one figure, are generally labeled with the same or similar number in all the figures in which they appear. It should be noted that the elements or parts in the figures are not necessarily shown to scale and each elements or part may be larger or smaller than actually shown.

FIG. 1 is a schematic illustration of an entity with an identification tag having a memory for recording interactions of a supply chain of an entity, according to an exemplary embodiment of the disclosure;

FIG. 2 is a schematic illustration of elements of an identification tag for recording interactions of a supply chain of an entity, according to an exemplary embodiment of the disclosure; and

FIG. 3 is a flow diagram of a method of verifying interactions of a supply chain of an entity, according to an exemplary embodiment of the disclosure.

### DETAILED DESCRIPTION

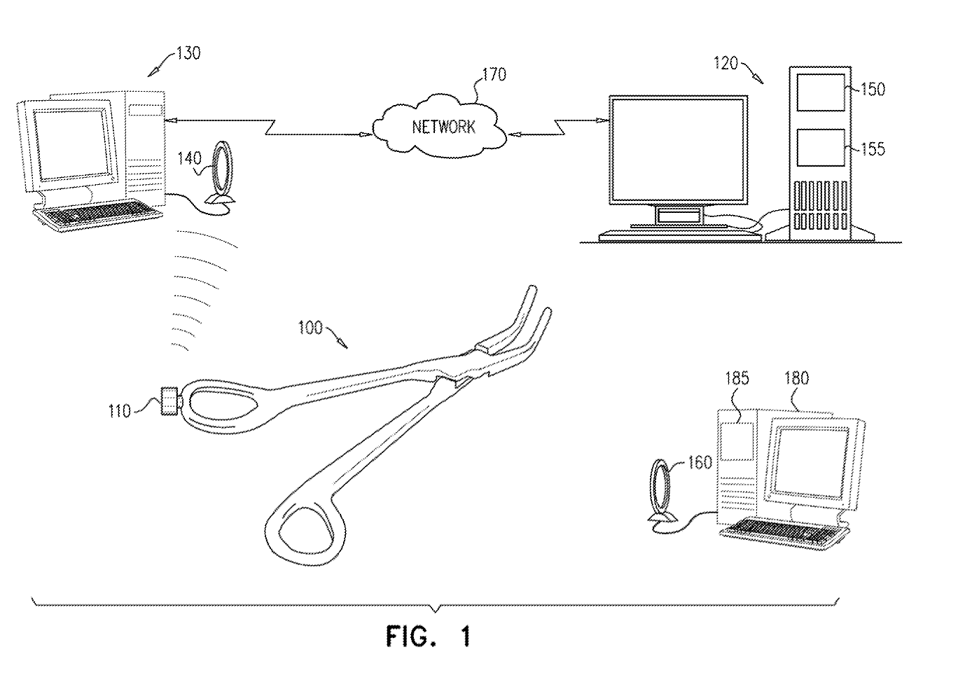

FIG. 1 is a schematic illustration of an entity 100 with an identification tag 110 having an internal memory for recording interactions of a supply chain of the entity, according to an exemplary embodiment of the disclosure. In an exemplary embodiment of the disclosure, identification tag 110 is attached to entity 100 when it is manufactured.

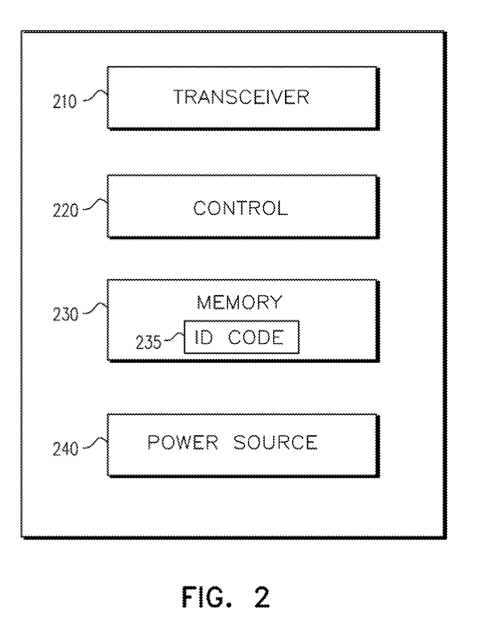

FIG. 2 is a schematic illustration of elements of the identification tag 110 for recording interactions of the supply chain of the entity, according to an exemplary embodiment of the disclosure. In an exemplary embodiment of the disclosure, the identification tag 110 serves as a circuit (e.g. RFID circuit) that is preprogrammed with a unique identification code 235 for identifying the entity. The identification code 235 may be recorded in a non-rewritable and non volatile memory, so that it will not be changed during the lifetime of the entity. Optionally, identification tag 110 includes a transceiver 210 for transmitting and/or receiving an RF signal. In an exemplary embodiment of the disclosure, identification tag 110 includes a control circuit 220 for analyzing incoming signals, storing information in a memory 230, preparing a response and outputting outgoing signals. Optionally, the identification tag also includes a power source 240, for example a battery. Alternatively, the identification tag may be passive and function by utilizing or storing power from received transmissions.

In an exemplary embodiment of the disclosure, a server computer 120 keeps a list 150 of all entity types and procedures that the entity 100 of each type need to undergo, for example sterilization, sharpening, packaging, coating, quality checking, storing, shipping. Likewise server computer 120 may keep a entity list 155 with the identification information from identification tags attached to entities 100, so that server 120 can identify the entity type by its identification information (e.g. code). List 155 may also record the procedures that need to be performed on a specific entity 100 and/or the procedures that were actually performed on the specific entity 100 based on its identification tag 110.

In an exemplary embodiment of the disclosure, the memory 230 of entity 100 is initially written with a list of procedures required for each type of entity. Optionally, memory 230 includes an indicator value for each procedure to designate if the procedure was performed or not. In some embodiments of the disclosure, the indicator provides additional information, for example a level of success or a procedure score. Optionally, each workstation computer 130 at a procedure station can update the information in the identification tag 110 of entity 100 before or after performing the procedure at the station. Likewise any workstation computer 130 can read the information on the identification tags, so that any procedure station can determine, which procedures were performed and which procedures need to be performed on entity 100.

In some embodiments of the disclosure, workstation computer 130 relies only on the information recorded in the identification tag 110 of entity 100. Alternatively or additionally, workstation computer 130 is connected with a live connection (e.g. over a network 170) to server computer 120 to verify and/or update the list of procedures recorded in the identification tag. For example specific procedures may be canceled or added for handling a specific type of entity 100. The server computer 120 may also be updated with information on the identification tag 110, so that the server knows what procedures were performed with a specific entity 100 and can issue entity specific instructions, for example that a specific entity 100 will be handled by a specific procedure. In some embodiments of the disclosure, workstation computer 130 is updated periodically by server computer 120 or server computer 120 may provide updates regarding the procedures required for entity 100, which can be downloaded from server computer 120 by workstation computer 130.

In an exemplary embodiment of the disclosure, a customer computer 180 is not provided with access to the information on server computer 120. Optionally, the customer workstation 180 is provided with a software application 185 and an identification tag reader 160 to count the entities 100 and access the information stored on the identification tags 110. In an exemplary embodiment of the disclosure, the customer may receive a shipment with of one or more entities 100, for example containing M units of a first entity and N units of a second entity. In an exemplary embodiment of the disclosure, customer computer 180 with reader 160 automatically read all the tags in the package to count the number of entities 100 of each type. Optionally, the information read from each entity 100 is analyzed to determine if all the required procedures have been performed for entity 100.

In an exemplary embodiment of the disclosure, the information stored on the identification tag 110 is encrypted, so that only authorized computers with an authorized computer program may access the information, for example software application 185 that is installed on customer workstation 180. Optionally, software application 185 is also installed on workstation computers 130 to deal with the information in the identification tags 110. In some embodiments of the disclosure, a XOR encoding algorithm is used to encrypt each byte of memory 230. Optionally a key is provided with software application 185 so that the customer workstations 180 and workstation computers 130 can all read and write the information on the identification tags 110. Software applications that do not have the encryption key cannot access the information stored on the identification tags 110. In some embodiments of the disclosure, the unique identification code is readable by any standard reader, e.g. an RFID reader, however the process information is encrypted so that non authorized stations cannot alter information.

In an exemplary embodiment of the disclosure, when initializing the identification tag 110 (e.g. associating it to an entity and/or writing a list of processes to be performed, in the memory 230 of the identification tag 110), the unique identification code 235 may be read by the initializing workstation computer 130, encrypted and stored in the memory 230. Optionally, when other workstation computers 130 read the information of the identification tag 110 they read the identification code 235, apply the same encryption scheme and compare the results to the previously stored and encrypted information to verify that the tag is an authentic tag. If the results do not match the tag is assumed to be damaged or illegal.

Optionally, the encryption scheme may be applied to the entire identification code 235 or to some of the bytes, for example the least significant bytes (e.g. 4 of 8 bytes). In some embodiments of the disclosure, all the information written to memory 230 is encrypted by software application 185 and an appropriate application (such as software application 185) is required to read the information. Alternatively, only the identification code or part of the identification code is written to the memory in an encrypted form, for authentication.

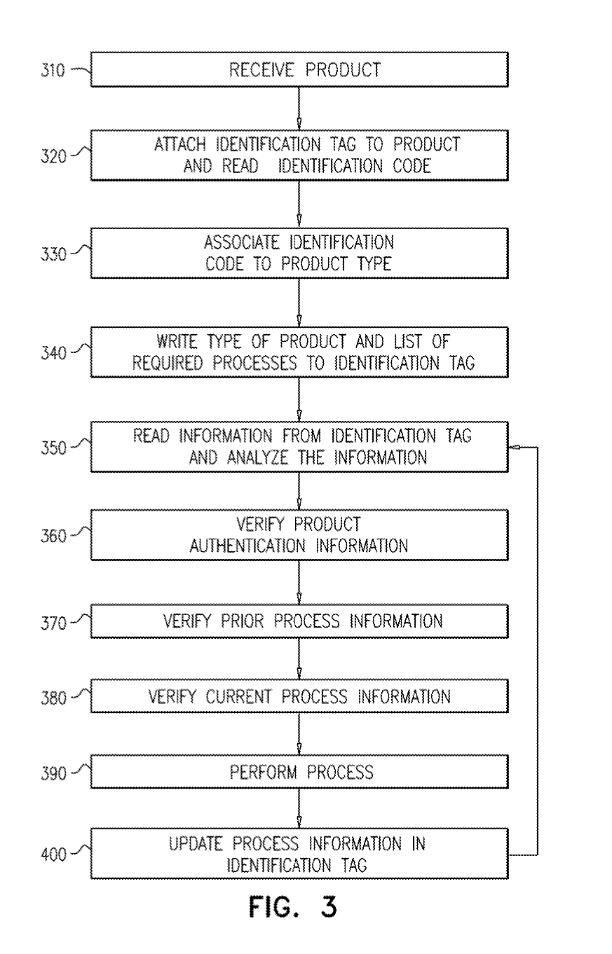

FIG. 3 is a flow diagram of a method 300 of verifying interactions of a supply chain of an entity 100, according to an exemplary embodiment of the disclosure. In an exemplary embodiment of the disclosure, an entity 100 is received (310) at an attachment station, e.g. represented by workstation computer 130. An identification tag 110 is attached (320) to the entity. The identification code 235 of the identification tag 110 is read by antenna 140. The type of entity 100 is recorded, e.g. by the user, so that the identification code 235 can be associated (330) with the type of entity 100. In some embodiments of the disclosure, workstation computer 130 may update server computer 120 and receive a list of processes that need to be performed for entity 100. Optionally, the entity type and list of processes are written (340) on the identification tag 110, so that the information is available on the identification tag 110 and travels with the entity 100.

In an exemplary embodiment of the disclosure, at each processing station the workstation computer 130 reads (350) information from the memory 230 of the identification tag 110 and analyzes it to verify (360) entity authentication information, for example that entity type is correct. Additionally, the information recorded on the identification tag 110 may be encrypted and/or may be written with an error detection code provided by workstation computer 130 (e.g. CRC or checksum value) to verify that the information was recorded correctly by an authorized workstation computer 130. After verifying the entity authentication information the workstation computer 130 verifies (370) that required prior processes are marked as performed. If a required process was skipped the entity can be returned for evaluation or to perform the missing process. Afterwards workstation computer 130 verifies (380) that the current process needs to be performed, workstation computer 130 instructs the station to perform (390) the process and update (400) the process results in the identification tag 110 attached to the entity 100. In some embodiments of the disclosure, the prior process data read (350) from the identification tag 110 may be used in performing the current process. Optionally, the process results may include an indication that the process was performed, an indication if the process was completed successfully or failed, or a completion value, for example a completion score. Upon completing a process the entity 100 may be sent to another processing station and repeat steps 350 to 400.

In an exemplary embodiment of the disclosure, customers can be equipped with software application 185 to check entities without being connected to server computer 120. Optionally, software application 185 uses reader 160 to read the information on the identification tags 110 in a package of entities 100. In an exemplary embodiment of the disclosure, customer computer 180, analyzes the information to verify that all the entities 100 are authenticated, e.g. having a valid encryption and/or a correct error detection code (e.g. CRC or checksum value). Likewise that all the entities 100 have been processed by all required processes. If any problems are found a problematic entity can be located and rejected by the customer.

In an exemplary embodiment of the disclosure, handling the entity supply chain discussed above is analogously the same as handling a workflow of processes. Thus the identification tag 110 may identify process anomalies and or record processes performed by an entity supply chain or a workflow of processes on an entity such as a person, animal or any other item/product with an identification tag attached, for example handling a patient and or medical device/instrument in a healthcare facility, an animal in an animal handling facility, an article of manufacture and any item that needs to be processed.

In an exemplary embodiment of the disclosure, identification tag 110 is attached to a patient's file that goes with the person in the healthcare facility or the identification tag may be attached directly to the entity (e.g. person, patient, animal, article of manufacture). Optionally, workstation computer 130 is used by practitioners to identify process anomalies during a process that a patient is undergoing and/or record processes that were performed on the patient and/or processes that need to be performed on the patient. Before each process the practitioner accesses the identification tag 110 of the patient's file to authenticate the identification tag 110 and load the information regarding the processes performed on the patient and the processes that need to be performed on the patient. The practitioner can then use the information to treat the patient and update the information in the identification tag 110 for future use. In some embodiments of the disclosure the workstation computer 130 may additionally access server computer 120 and update the information on the server computer 120, although access to the server computer 120 is not required for treatment since required information is recorded in identification tag 110.

In an exemplary embodiment of the disclosure, the processes may include an operation or treatment that is performed in stages, for example in which the patient is sealed and then reopened for further treatment. Optionally, at the end of a stage, workstation computer 130 via tag reader 140, automatically reads the identity codes of items (e.g. tools, sponges, bandages and other items) that are intentionally left inside the body of the patient. The identification codes of the items left inside the patient are recorded in the memory 230 of the identification tag 110 that is attached to the patient's file. In an exemplary embodiment of the disclosure, when starting the next stage, workstation computer 130 uses tag reader 140 to locate these items based on the information previously recorded in the identification tag 110 of the patient's file. Optionally, at each stage of the operation workstation computer 130 verifies that items that should be there are there and the items that shouldn't are not.

In some embodiments of the disclosure, the patient's file includes a folder for inserting documents and/or a hardcopy of the information recorded in the identification tag 110, for example a handwritten or printed copy. Alternatively, the identification tag 110 may be worn by the patient, for example as a bracelet or necklace.

In an exemplary embodiment of the disclosure, workstation computer 130 can be a desktop computer, a laptop computer, a tablet, a smartphone or other type of computing device. Optionally, tag reader 140 may communicate wirelessly with workstation computer 130 (e.g. using Wi-Fi, Bluetooth or other protocols) to provide the content of identification tags 110.

It should be appreciated that the above described methods and apparatus may be varied in many ways, including omitting or adding steps, changing the order of steps and the type of devices used. It should be appreciated that different features may be combined in different ways. In particular, not all the features shown above in a particular embodiment are necessary in every embodiment of the disclosure. Further combinations of the above features are also considered to be within the scope of some embodiments of the disclosure. It will also be appreciated by persons skilled in the art that the present disclosure is not limited to what has been particularly shown and described hereinabove.

I/We claim:

1. An identification tag that is attachable to an entity and serves to monitor the supply chain of the entity or workflow of processes applied to the entity, comprising:
a transceiver for receiving transmissions and transmitting a response;
a memory for storing information;
a control for analyzing incoming information, storing information in the memory and providing information from the memory;
wherein the memory is preprogrammed with a unique identification code and is configured to store information defining the type of entity attached to the identification tag, a list of processes required to be performed on the entity and status information of the list of processes.

2. An identification tag according to claim 1, wherein the identification tag is powered by received electromagnetic signals.

3. An identification tag according to claim 1, wherein the identification tag is powered by a battery.

4. An identification tag according to claim 1, wherein the identification tag is programmed to notify a reader of a processing station with the information of the type of entity it is attached to, based on the information in the memory.

5. An identification tag according to claim 1, wherein the identification tag is programmed to notify a reader of a processing station if the entity is required to undergo a process performed by a processing station based on the information in the memory.

6. An identification tag according to claim 1, wherein the status information stored in the memory includes a score for processes performed on the entity.

7. An identification tag according to claim 1, wherein the status information stored in the memory includes an indication if a process was performed or not, on the attached entity.

8. An identification tag according to claim 1, wherein the information stored in the memory is encrypted so that it is readable and writable only by authorized processing stations.

9. An identification tag according to claim 1, wherein the information stored in the memory includes an error detection code to authenticate that the information was recorded by an authorized processing station.

10. An identification tag according to claim 1, wherein the information stored in the memory enables a processing station to verify that prior required processes were performed on the entity before performing a process by the processing station.

11. A method of monitoring the supply chain of an entity or workflow of processes applied to the entity, comprising:
receiving an entity;
attaching an identification tag to the entity; wherein the identification tag comprises: 1) a transceiver for receiving transmissions and transmitting a response, 2) a memory preprogrammed with a unique identification code and for storing information, and 3) a control for analyzing incoming information, storing information in the memory and providing information from the memory;
identifying a type of the entity;
writing the type of entity to the memory;
writing a list of required processes for the entity to the memory;
providing the entity to a processing station to perform a process;
reading information from the memory of the identification tag;
analyzing the information read from the memory;
based on said analyzing determining if to perform the process for the entity or to transfer the entity to a different processing station to perform a different process; and
updating the information in the tag based on the results of the process.

12. A method according to claim 11, further comprising:
downloading from a server computer over a network the list of required processes based on the type of entity.

13. A method according to claim 11, wherein said analyzing comprises verifying that the type of entity written in the memory is correct.

14. A method according to claim 11, wherein said analyzing comprises verifying that the information written in the memory has a correct error correction code.

15. A method according to claim 11, wherein said analyzing comprises verifying that the information written in the memory was encoded correctly.

16. A method according to claim 11, wherein said analyzing comprises verifying that required prior processes are marked as performed.

17. A method according to claim 11, wherein said analyzing comprises verifying that the process was not performed yet for the entity.

18. A method according to claim 11, wherein said unique identification code is associated with the type of entity in a list on a server computer that is accessible over a network.

19. A method according to claim 11, wherein the memory is used to record a list of identification codes of items used in a first process and to verify that the recorded items exist or are removed in a second process.

20. A system for monitoring the supply chain of an entity or workflow of processes applied to the entity, comprising:
A reader configured to read the information of an identification tag as in claim 1 that is attached to the entity;
a workstation computer at a processing station with a software application for reading and writing information in a memory of the identification tag;
wherein the software application associates the unique identification code stored in the memory of the identification tag with the type of entity and provides the list of required processes to be written in the memory of the identification tag.

21. A system as in claim 20, further comprising a server computer that is connected over a network to multiple workstation computers and forms a list of identification codes and their associated entity type from information provided by the multiple workstation computers.

22. A system as in claim 21, wherein the server computer provides the list of required processes to the multiple workstation computers.
